(19) United States
(12) Patent Application Publication
(10) Pub. No.: US 2013/0236011 A1
(43) Pub. Date: Sep. 12, 2013

(54) Method for Transmitting Sensor Data

(71) Applicant: Klaus Schwarze, Duderstadt (DE)

(72) Inventor: Klaus Schwarze, Duderstadt (DE)

(21) Appl. No.: 13/818,931

(22) PCT Filed: Aug. 9, 2011
(86) PCT No.: PCT/EP11/63689

§ 371 Date: May 15, 2013

(30) Foreign Application Priority Data
Aug. 26, 2010 (DE) 10-2010-039-845.4

(51) Int. Cl. H04L 29/06

(52) U.S. Cl. CPC H04L 63/0428
USPC 380/255

(57) ABSTRACT

A method and a sensor system for transmitting sensor data are described. It is provided in the method that a sensor outputs an analog signal, a digital signal is generated as a function of the analog signal, the digital signal is encrypted and both the analog signal and the encrypted digital signal are transmitted to a receiver unit.

### FIELD OF THE INVENTION

The present invention relates to a method for transmitting sensor data, as well as a sensor system and a receiver unit for carrying out the method.

### BACKGROUND INFORMATION

In motor vehicles, sensors are used to receive physical and chemical properties qualitatively or quantitatively as the measured variable. The sensor data representing the measured variable are then transferred by the sensor to the control units in the motor vehicle. The sequences in the motor vehicle are controlled and/or regulated based on these sensor data.

A sensor may transmit an analog signal which carries information regarding the received measured variable. If this signal is manipulated, intervention into the sequences or processes of the motor vehicle, e.g., the engine control, are possible.

A possible procedure for increasing the performance of motor vehicles, the so-called tuning, entails using ballasts, which are also referred to as power boxes, to falsify sensor signals. Here, falsified measured values, e.g., boost charge, injection pressure, and air mass, are predefined for the engine control unit in order to generate an increased engine output. The ballasts can usually not be recognized by the software of the engine control unit. In the case that such a procedure results in an engine damage, it is possible to easily remove the ballasts to shift the costs to the warranty.

For this reason, a safe and secure sensor data transmission is striven for which means that a sensor data transmission is carried out which cannot be manipulated or for which a manipulation may be recognized and thus also indicated.

One procedure provides a digitally signed transmission of a measured value, the measured value being digitized in the sensor system and signed using a private key of the sensor system. The receiver unit, regularly a control unit, checks with the aid of the public key whether the signature is correct. The transmission no longer takes place as an analog value, but as a bit stream on a digital line which is designed as a bus, for example. For this purpose, the key distribution and the transmission of the public keys to the control units, e.g., in the case of sensor exchange, must be ensured through suitable learning methods or trust centers.

Publication DE 10 2004 021 660 A1 discusses the transmission of sensor data in a motor vehicle having an internal combustion engine generating an exhaust gas. A measured value which is correlated to the speed and which is transmitted to a tachograph for recording a speed characteristic is measured using a first sensor. The tachograph is connected to a second sensor using which a measured value correlated to a urea supply is measurable. This measured value may be transmitted digitally to the tachograph in an encrypted manner.

Publication U.S. Pat. No. 5,898,782 B discusses a method for safe and secure transmission of data elements between a sensor and a recording unit, the sensor providing impulses which are processed by the recording unit. In the method, encrypted data elements are exchanged which, in turn, include digital command messages.

A transmission of sensor data is striven for which is safe and secure and, at the same time, allows a sufficiently rapid transmission of the data detected with the aid of the sensor system.

### SUMMARY OF THE INVENTION

A method having the features described herein, a sensor system according to the description herein, and a receiver unit according to the description herein are presented. Embodiments result from the descriptions herein.

With the aid of the described method, it is thus possible to transmit measured values, e.g., pressure, air mass, etc., in a cryptographically safe and secure manner using “intelligent” sensors. Compared to a pure transmission of digital data, the presented method also allows a rapid transmission of the data.

The sensor system has an additional, rapid analog output which is not secured but which allows a sufficiently rapid transmission of data. An encryption method is, for example, additionally used via a sliding mean value, and the encrypted data are transmitted to the receiver unit, e.g., a control unit. The digitized, rapid analog signal goes through the same process in the control unit. Subsequently, a plausibility check may help to determine whether the analog signal has been falsified.

This plausibility check takes place in regular intervals, for example, and in parallel to the transmission of the analog signal. If the plausibility check determines a manipulation, it is possible to stop the transmission of the analog data and/or to output a corresponding warning.

Symmetric and asymmetric encryption methods may be used for the encryption. It is, for example, possible to use a certificate-based method, e.g., SSL (Secure Sockets Layer). This may be used in the engine control, for example, as a protection against tuning measures, but also as a protective measure against product piracy.

The method may basically be used in all sensors whose output signals are to be protected against manipulation.

Further advantages and embodiments of the present invention result from the description and the appended drawings.

It is understood that the above-named features and the features to be elucidated below are usable not only in the particular given combination, but also in other combinations or alone, without departing from the scope of the exemplary embodiments and/or exemplary methods of the present invention.

### BRIEF DESCRIPTION OF THE DRAWINGS

FIG. 1 shows a system according to the related art.

FIG. 2 shows an embodiment of the sensor system and an embodiment of the receiver unit for carrying out the presented method.

FIG. 3 shows a characteristic of a combined signal.

### DETAILED DESCRIPTION

The exemplary embodiments and/or exemplary methods of the present invention are illustrated schematically on the basis of specific embodiments in the drawings and is described in greater detail in the following with reference to the drawings.

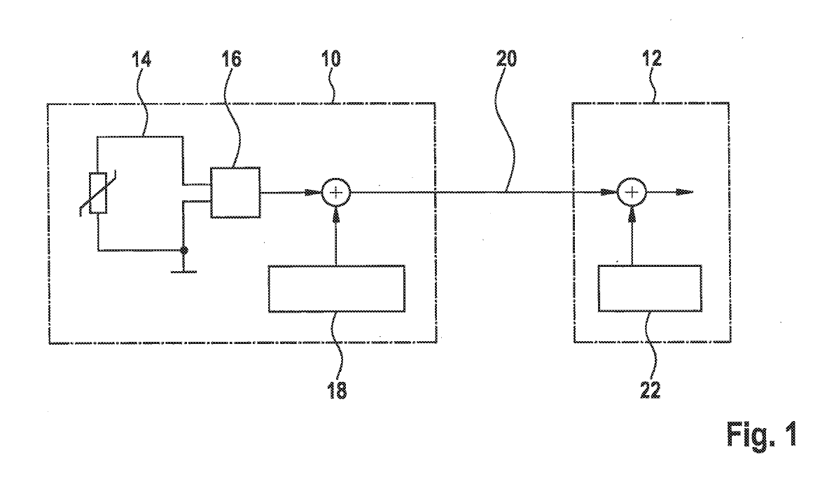

FIG. 1 illustrates a sensor system, denoted with reference numeral 10 as a whole, according to the related art. Furthermore, the illustration shows a receiver unit 12, in this case a control unit, which receives measured data from sensor system 10.

Sensor system 10 has a sensor 14, an analog/digital converter 16 and a memory unit 18. A private key is stored in memory unit 18. A digital line 20 is provided for transmitting the data. Another memory unit 22, in which a public key is stored, is provided in receiver unit 12.

In this way, a digitally signed transmission of measured values takes place, the received measured values being digitized in sensor system 10 and signed using the private key. Receiver unit 12 checks using the public key whether the signature is correct. Consequently, the transmission no longer takes place as an analog value, but as a bit stream on digital line 20.

The disadvantage of the method described in FIG. 1 is that a rapid transmission of the data is not possible due to the requirement of continuously digitizing and encrypting the received data, before these data are transmitted.

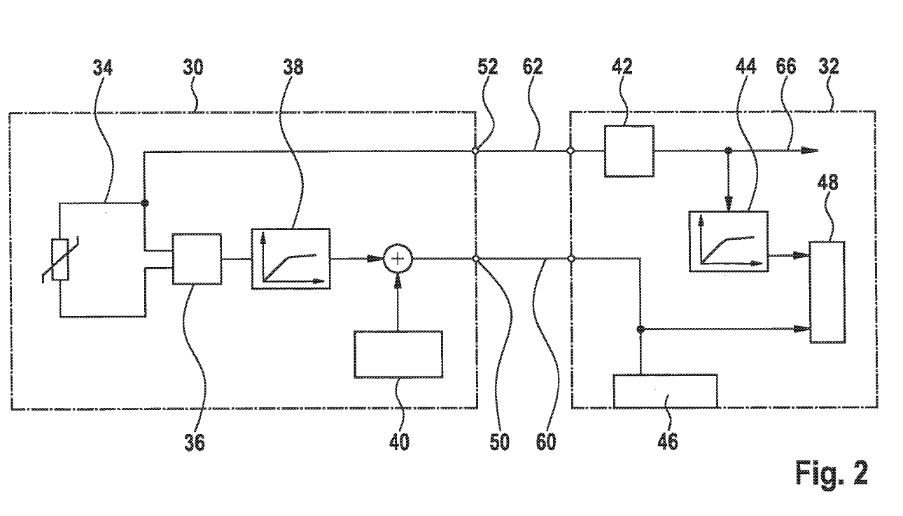

FIG. 2 shows a representation of a specific embodiment of the described sensor system which is denoted with reference numeral 30 as a whole. Furthermore, the illustration shows a receiver unit 32 which is designed as a control unit. Sensor system 30 and receiver unit 32 form a unit for carrying out the presented method.

Sensor system 30 includes a sensor 34, an analog/digital converter 36, an arithmetic unit 38 for mean value formation, and an encryption unit 40. Receiver unit 32 has an analog/digital converter 42, an arithmetic unit 44 for mean value formation, a decryption unit 46, and an arithmetic unit 48 for a plausibility check.

In contrast to sensor system 10 illustrated in FIG. 1, sensor system 30 illustrated in FIG. 2 is suitable in particular when a digital transmission of the measured data alone is too slow. Sensor system 30 has a first output 50 for the encrypted digital signal and a second output 52 which represents a rapid analog output which is not secured.

A first line 60, via which the encrypted digital signal is transmitted, is provided for transmitting the measured data. Furthermore, a second line 62 is provided via which the analog signal is transmitted. With the aid of the two lines 60 and 62, it is thus possible to transmit both the analog signal and the encrypted digital signal, in particular simultaneously. Alternatively, it is also possible to transmit the two signals via one single line. In this case, a combined signal is transmitted which carries information regarding the analog signal and the encrypted digital signal.

In illustrated sensor system 30, an encryption method is additionally used after the formation of a sliding mean value. In receiver unit 32, the received analog signal goes through the same process. Subsequently, a plausibility check determines whether the analog signal has been falsified. The analog signal is thus compared to the encrypted digital signal. This analog signal, which has been checked for plausibility, may then be further used (arrow 66). The analog signal is usually used until a manipulation is determined.

The mean value formation is carried out so that there is no need to encrypt the digital value permanently, but a mean value of the digitized analog signal is encrypted only at predeterminable points in time. This mean value carries a piece of information regarding the characteristic of the signal over the time period during which the mean value formation was carried out.

In FIG. 2, two lines 60 and 62 are provided for measured data transmission. Basically, the method may also be carried out using only one line. In this case, the analog signal and the encrypted digital signal must be transmitted via this one line. This may take place by the two signals being consecutively transmitted. Another possibility provides that the digital signal is modulated on the analog signal. For this purpose, a frequency modulation or also an amplitude modulation may be carried out. In this case, a combined signal which carries the information of the analog and the digital signals is transmitted via one line.

Here, it is also possible that the digital signal is modulated on the analog signal over the entire course of the analog signal. Alternatively, modulating the digital signal on the analog signal only during specific time intervals of the analog signal is also conceivable. In any case, it is necessary to provide a device in the receiver unit using which the two portions of the combined signal, namely the analog signal and the encrypted digital signal, may be extracted.

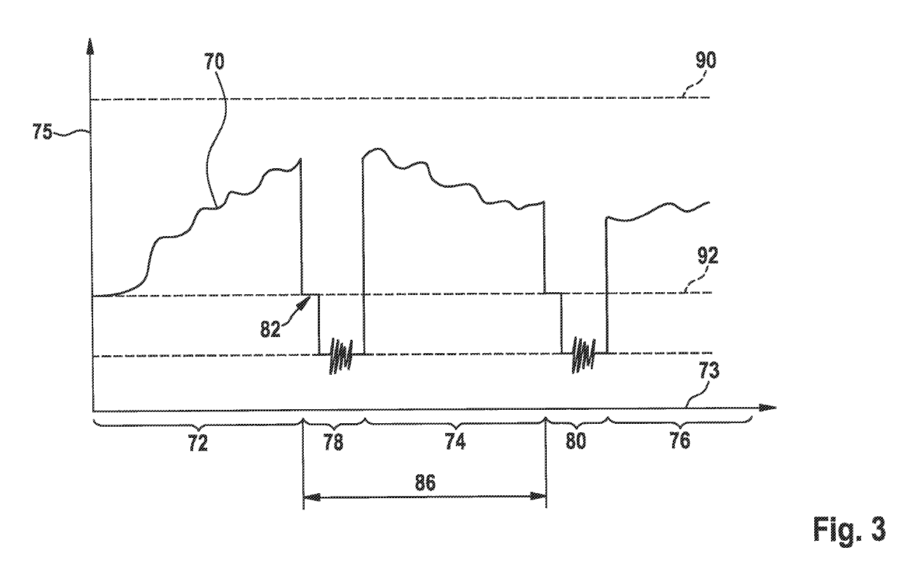

In FIG. 3, the characteristic of a combined signal 70 is illustrated which has intervals 72, 74, and 76, during which only an analog signal is transmitted, and intervals 78 and 80 during which the digital signal is modulated on the analog signal. In this case, time t is plotted on an abscissa 73 and voltage U is plotted on an ordinate 75.

An arrow 82 illustrates the start of the modulated digital signal, and another arrow 84 illustrates the modulated digital signal. A time period T 86 indicates the time period between two chronologically consecutive modulations and suggests a type of period.

A first dashed line 90 indicates the maximum analog value. A second dashed line 92 indicates the analog value zero. Here, it is important that during the modulation the combined signal is pulled into a voltage range which cannot be reached by the analog signal. This simplifies the extraction.

1-10. (canceled)

11. A method for transmitting sensor data, the method comprising:
outputting, via a sensor, an analog signal;
generating a digital signal as a function of the analog signal;
encrypting the digital signal to provide an encrypted digital signal; and
transmitting the analog signal and the encrypted digital signal to a receiver unit.

12. The method of claim 11, wherein the analog signal and the encrypted digital signal are transmitted via one line.

13. The method of claim 12, wherein a modulated signal is transmitted via the one line.

14. The method of claim 11, wherein the analog signal and the encrypted digital signal are compared to one another in the receiver unit.

15. The method of claim 14, wherein the analog signal is digitized prior to the comparison.

16. The method of claim 11, wherein the digital signal is subjected to a mean value formation prior to being encrypted.

17. The method of claim 15, wherein the received analog signal is digitized and then subjected to a mean value formation.

18. A sensor system, comprising:
a sensor, which receives measured values and which provides an analog signal;
an analog/digital converter for providing a digital signal as a function of the analog signal; and
an encryption unit for encrypting the digital signal to provide an encrypted digital signal;
a transmitting arrangement to transmit the analog signal and the encrypted digital signal to a receiving unit.

19. The sensor system of claim 18, further comprising:
an arithmetic unit for providing a mean value formation.

20. A receiver unit for receiving an analog signal and an encrypted digital signal from a sensor system, comprising:
an analog/digital converter for converting the analog signal and the encrypted digital signal;
a decryption unit to decrypt the encrypted digital signal; and
an arithmetic unit for performing a plausibility check.
